(19) United States
(12) Patent Application Publication
(10) Pub. No.: US 2005/0161061 A1
(43) Pub. Date: Jul. 28, 2005

(54) Methods for cleaning a set of structures comprising yttrium oxide in a plasma processing system

(76) Inventors: Hong Shih, Walnut, CA (US); Anthony L. Chen, Pleasanton, CA (US); Sok Kiow Tan, Union City, CA (US); Stephen Hwang, Fremont, CA (US); John Daugherty, Newark, CA (US); Bruno Morel, Santa Clara, CA (US)

Correspondence Address: IPSG, P.C., P.O. BOX 700640, SAN JOSE, CA, 95170-0640, US

(21) Appl. No.: 10/666,331

(22) Filed: Sep. 17, 2003

(51) Int. Cl. B08B 7/00

(52) U.S. Cl. 134/26; 134/6

(57) ABSTRACT

A method of removing a set of particles from a set of structures including yttrium oxide is disclosed. The method includes exposing the set of structures to a first solution including an oxidizer for a first period. The method also includes removing the set of structures from the first solution, and exposing the set of structures to a second solution including a keytone reagent for a second period. The method further includes removing the set of structures from the second solution, and mechanically rubbing the set of structures with a third solution including a first set of acids for a third period.

### BACKGROUND OF THE INVENTION

The present invention relates in general to substrate manufacturing technologies and in particular to methods for cleaning a set of structures comprising yttrium in a plasma processing system.

In the processing of a substrate, e.g., a semiconductor wafer or a glass panel such as one used in flat panel display manufacturing, plasma is often employed. As part of the processing of a substrate (chemical vapor deposition, plasma enhanced chemical vapor deposition, physical vapor deposition, etc.) for example, the substrate is divided into a plurality of dies, or rectangular areas, each of which will become an integrated circuit. The substrate is then processed in a series of steps in which materials are selectively removed (etching) and deposited (deposition) in order to form electrical components thereon.

In an exemplary plasma process, a substrate is coated with a thin film of hardened emulsion (i.e., such as a photoresist mask) prior to etching. Areas of the hardened emulsion are then selectively removed, causing parts of the underlying layer to become exposed. The substrate is then placed in a plasma processing chamber on a substrate support structure comprising a mono-polar or bi-polar electrode, called a chuck. Appropriate etchant source gases (e.g., C₄F₈, C₄F₆, CHF₃, CH₂F₃, CF₄, CH₃F, C₂F₄, N₂, O₂, Ar, Xe, He, H₂, NH₃, SF₆, BCl₃, Cl₂, etc.) are then flowed into the chamber and struck to form a plasma to etch exposed areas of the substrate.

A plasma processing system may also produce pollutants that are deposited on the interior surfaces of the plasma processing system. These deposits are generally comprised of organic and inorganic byproducts generated by the plasma process from materials in the etchant gases (e.g., carbon, fluorine, hydrogen, nitrogen, oxygen, argon, xenon, silicon, boron, chlorine, etc.), from materials in the substrate (e.g. photoresist, silicon, oxygen, nitrogen, aluminum, titanium, etc.), or from structural materials within the plasma processing chamber itself (e.g., aluminum, quartz, etc.).

The degree of deposit adhesion to surfaces within the chamber, and hence the subsequent degree of potential contamination, is usually dependent on the specific plasma processing recipe (e.g., chemistry, power, and temperature) and the initial surface condition of chamber process kits. In general, organic bonds tend to be very strong and adhesive (i.e., C—H, C—C, C═C, C—O, C—N, etc.), since cross-linked relatively stable structures are created. Subsequently, residues with high organic content tend to create substantially fewer contaminants than residues with low organic content. Furthermore, SEM analysis demonstrates the compact structure of organic-rich deposition and loose structure of inorganic-rich deposition.

Since substantially removing deposits may be time consuming, a plasma processing system chamber is generally substantially cleaned only when particle contamination levels reach unacceptable levels, when the plasma processing system must be opened to replace a consumable structure (e.g., edge ring, etc.), or as part of scheduled preventive maintenance (PM). Furthermore, in many implementations, the time interval between these substantial cleanings may be substantially extended by partially cleaning the plasma processing system in-situ by striking a plasma without the substrate present. For example, a fluorine plasma may be used to remove ambient pollutants from the plasma processing surfaces.

In addition many structures are further comprised of anodized aluminum in order to reduce the amount of generated inorganic deposits within a plasma processing system. Anodized aluminum generally provides a durable material that is substantially resistant to the corrosive chemistries used in plasma processing. Furthermore, an yttrium oxide (Y₂O₃) coating or layer, also called yttria, may be used to further protect surfaces within the plasma process chamber.

Yttria is substantially resistant to plasma, and thus may significantly further reduce aluminum contamination. Like anodized aluminum, yttria is electrically insulating, and has a relatively low dielectric constant. However, an yttria coating is also susceptible to damage in the process of removing deposits from a structure, particularly when corrosive substances are used during a wet cleaning. For example, it is commonly known that inorganic acids (e.g., HNO₃, HCl, HF, H₂SO₄, etc.), although effective in removing deposits from plasma processing structures, may also attack yttria and cause substantial corrosion. This damage may be further aggravated when etch deposits on the yttria coating react with ambient moisture to cause undercut corrosion and delamination.

Referring now to FIG. 1, a simplified cross-sectional view of a plasma processing system is shown. Generally, an appropriate set of etchant source gases is flowed into chamber 102 through an inlet 108 and struck to form a plasma 110, in order to etch exposed areas of substrate 114, such as a semiconductor wafer or a glass pane, positioned on an electrostatic chuck 116. Gas distribution plate 120, along with liner 112, help to optimally focus plasma 110 onto substrate 114.

Many structures within a plasma processing system are further comprised of anodized aluminum 118 in order to resist to the corrosive chemistries used in plasma processing. Generally, anodized aluminum is formed by immersing the aluminum structure in a sulfuric acid electrolyte solution, through which voltage is passed. Charged anions to migrate to the anode where the oxygen in the anions to combine with the aluminum to form aluminum oxide (Al₂O₃). This anodized layer is commonly 2-3 mils in thickness, but is also generally porous and must be sealed to provide maximum resistance to corrosion. This may be accomplished through a hydrothermal treatment in proprietary chemical baths or by capping the pores via the precipitation of metal salts in the pore openings.

In addition, an yttria (Y₂O₃) coating may also be used to further protect a structure within a plasma processing system. Yttria is generally applied to anodized aluminum surfaces within the plasma processing system as a plasma spray coating. Yttria in the form of powder is injected into a very high temperature plasma flame, where it is rapidly heated and accelerated to a high velocity. The hot material impacts on the anodized aluminum surface and rapidly cools forming a coating.

A common feature of all thermal spray coatings is their lenticular or lamellar grain structure resulting from the rapid solidification of small globules, flattened from striking a cold surface at high velocities. This creates a substantially strong covering in which mechanical interlocking and diffusion bonding occur. However, since yttria is a thermally sprayed coating, it is also porous. And although porosity increases thermal barrier properties and increases thickness limitations, it also can create potential corrosion problems. That is, micro-fractures within the yttria coating can potentially allow chemicals to penetrate to the anodized aluminum substrate.

Referring now to FIG. 2 illustrates an idealized cross-sectional view of substrate 114, as shown in FIG. 1. In the discussions that follow, terms such as “above” and “below,” which may be employed herein to discuss the spatial relationship among the layers, may, but need not always, denote a direct contact between the layers involved. It should be noted that other additional layers above, below, or between the layers shown may be present. Further, not all of the shown layers need necessarily be present and some or all may be substituted by other different layers.

At the bottom of substrate 114, there is shown the base subtrate layer 214, typically comprising Si, above which may be oxidized oxide layer 212, typically comprising SiO₂. Above the oxidized oxide layer 212, may be barrier layer 210 comprised Ti/TiN. Above the barrier layer 210, may be a metal layer 208, commonly comprised of an aluminum (Al) alloy containing 0.5 to 2.0% copper (Cu), and generally used for interconnects and vias. Above metal layer 208, may be a barrier layer 206 comprised of Ti or TiN. Above barrier layer 206, may be a hard mask layer comprising SiON 204, and above that may be overlayed a photoresist layer 202. Photoresist layer 202 is commonly patterned for etching through exposure to ultra-violet rays. By way of example, one such photoresist technique involves the patterning of photoresist layer 202 by exposing the photoresist material in a contact or stepper lithography system to form a mask that facilitates subsequent etching. Materials of substrate 114, along with components of the etchant gases, and structural materials within the plasma processing chamber itself are commonly the source of organic and inorganic deposits.

In view of the foregoing, there are desired methods for cleaning a set of structures comprising yttrium in a plasma processing system.

### SUMMARY OF THE INVENTION

The invention relates, in one embodiment, to a method in a plasma processing system of removing a set of particles from a set of structures including yttrium oxide. The method includes exposing the set of structures to a first solution including an oxidizer for a first period. The method also includes removing the set of structures from the first solution, and exposing the set of structures to a second solution including a keytone reagent for a second period. The method further includes removing the set of structures from the second solution, and mechanically rubbing the set of structures with a third solution including a first set of acids for a third period.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 depicts a simplified cross-sectional view of a plasma processing system;

FIG. 2 illustrates an idealized cross-sectional view of substrate;

FIG. 3A-C illustrate simplified diagrams of a surface within a plasma processing system chamber, according to one embodiment of the invention; and

FIG. 4 depicts a simplified diagram showing steps for cleaning yttria coated structures in a plasma processing system, according to one embodiment of the invention.

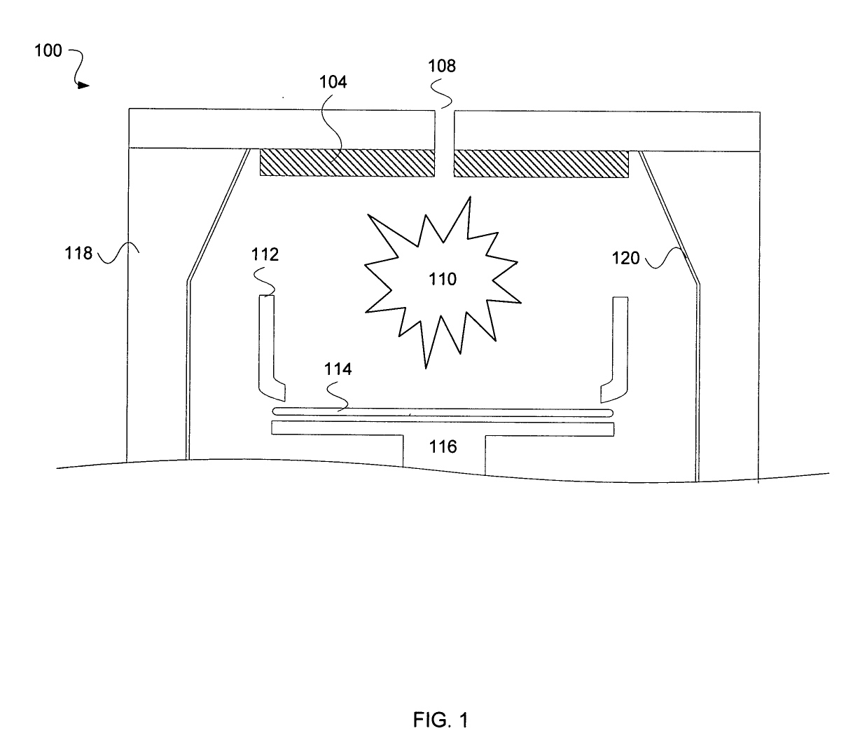

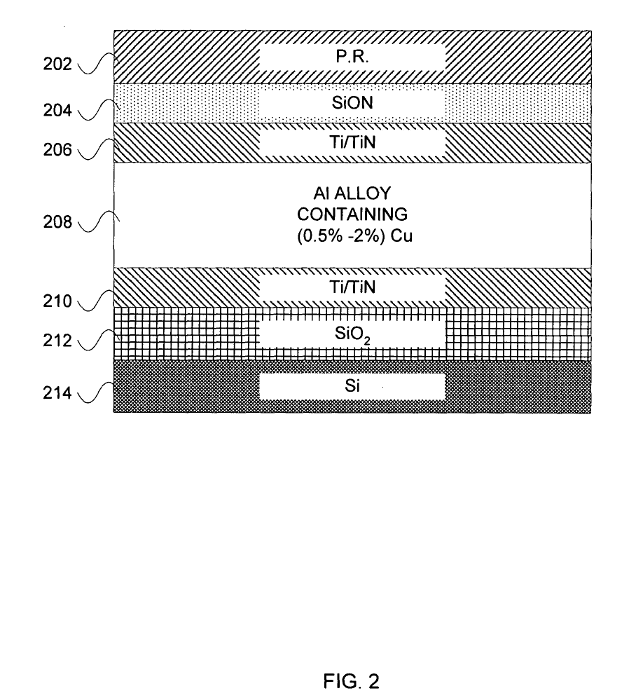

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

While not wishing to be bound by theory, it is believed by the inventor herein that in a plasma processing system, with an yttria thermal spray coating, is susceptible to undercut corrosion. As a substrate is processed in a plasma processing system, chlorine (Cl) may react with aluminum (Al) to form aluminum chloride (AlCl₃), an inorganic byproduct. This, in turn, tends to become suspended with organic material in deposits that adhere to surfaces within the plasma processing system chamber.

Structures within the plasma processing system are commonly protected with a ceramic covering, such as anodized aluminum (Al₂O₃). In addition, structures are further coated with an yttria layer to provide further protection. Both the anodized aluminum and yttria layers, however, are porous. Yttria, for example, may have a porosity of 4%. This means that some byproduct particles are able to mechanically pass through the layer to the underlying stratum and cause corrosion.

For example, as the interior of plasma processing system is exposed to the ambient atmosphere, some degree moisture (H₂O) may enter. This moisture may react with aluminum chloride suspended in the organic deposits to form hydrochloric acid (HCl):
2AlCl₃+3H₂O=2Al(OH)₃+6HCl

Subsequently, some of this ambient moisture, as well as the created hydrochloric acid particles, may diffuse through both the yttria layer and the anodized aluminum to reach the underlying aluminum stratum. Hydrochloric, in turn, may react with the aluminum to form hydrogen gas (H₂):
6HCl+2Al=2AlCl₃+3H₂

Additionally, the created aluminum chloride, may again react with moisture to form additional hydrochloric acid, starting the process again. As sufficient hydrogen gas is produced beneath the anodized aluminum layer, a gas pocket is formed. Eventually, hydrogen gas may create sufficient pressure to substantially damage the layers above it. That is, a blister may be formed that eventually causes the anodized aluminum and yttrium layers to flake off or peel.

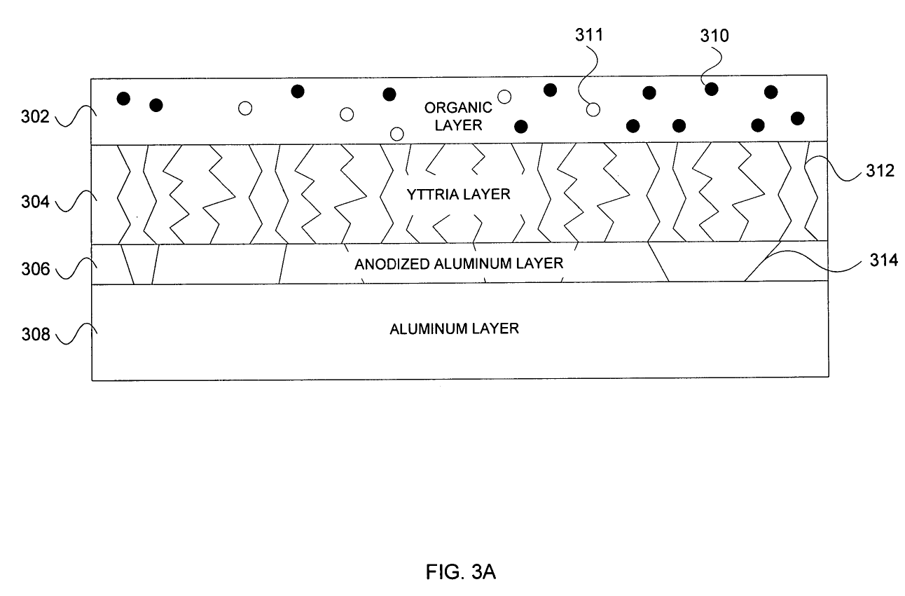

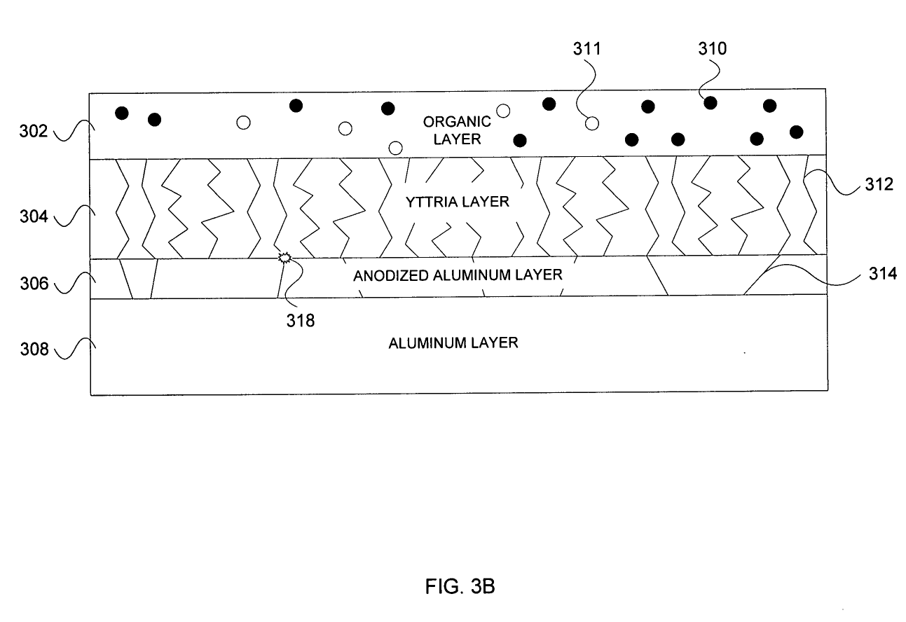

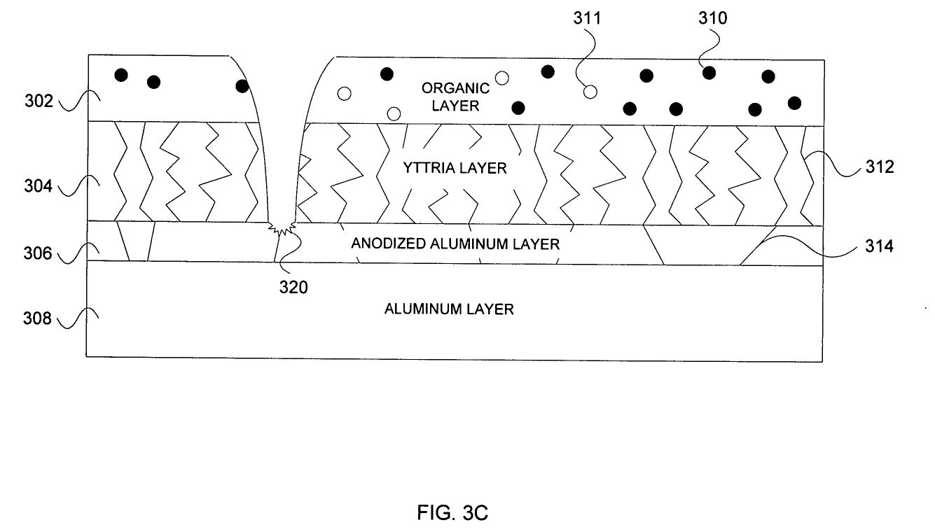

Referring now to FIG. 3A, a simplified diagram of a surface within the plasma processing system chamber is shown, according to one embodiment of the invention. Organic layer 302 comprises the set of deposits that adhere to surfaces within the chamber. In general, the degree of adhesion is usually dependent on the specific plasma processing recipe (e.g., chemistry, power, and temperature). It tends to be very strong and adhesive, creating cross-linked relatively stable structures. Inorganic molecules 310 comprise substances like aluminum chloride that may eventually react with water molecules 311 to create hydrogen gas pockets.

Yttria layer 304 is generally applied to anodized aluminum surfaces within the plasma processing system as a plasma spray coating in order to protect surfaces within a plasma process chamber. Micro-fractures 312 and 314 may allow ambient particles penetrate to the underlying anodized aluminum stratum 306, that may also be porous, and reach aluminum layer 308 (e.g., Al6061-T6).

Referring now to FIG. 3B, the simplified diagram of FIG. 3A is shown, in which a hydrogen pocket is formed. As previously described, water molecules 311 and aluminum chloride 310 suspended in organic layer 302, pass through yttrium layer 312 and anodized aluminum layer 314, and react form hydrochloric acid. This in turn reacts with aluminum to form hydrogen gas and more aluminum chloride.

Referring now to FIG. 3C, the simplified diagram of FIG. 3B is shown, in which pressure created by the hydrogen pocket has increased to the point of substantially damaging the layers above it 320. Blisters may occur on yttria coated surfaces and micro-cracks may also be observed on yttria coating surfaces. Coating may peel off due to the undercut corrosion. The blisters may be contributed by two factors (1) accumulation of hydrogen bubbles and pressure, (2) accumulation of corrosion byproducts such as AlCl₃.

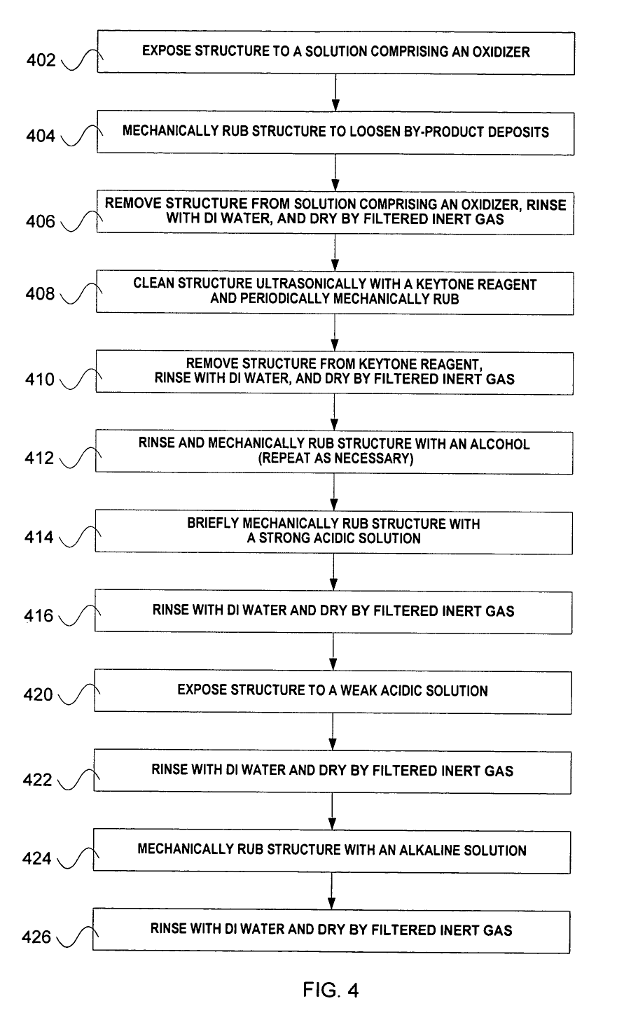

Referring now to FIG. 4, a simplified diagram showing steps for cleaning yttrium coated structures after the service in a plasma processing system, according to one embodiment of the invention. Although FIG. 4 shows a simplified set of sequential steps, other step sequences may also optimally clean yttrium coated structures in a plasma processing system.

In a non-obvious manner, the structure is exposed to a solution comprising an oxidizer, such as H₂O₂, at step 402. In one aspect of the invention, the solution comprises between about 10% and about 30% of the oxidizer. In another aspect of the invention, the solution comprises between about 20% and about 30% of the oxidizer. In another aspect of the invention, the solution comprises about 30% of the oxidizer.

While exposed, the structure is mechanically rubbed to loosen by-product deposits, at step 404. The structure is then removed, rinsed with DI (de-ionized) water, and dried by a filtered inert gas, such as nitrogen, at step 406. The structure is then ultrasonically cleaned with a keytone reagent, such as acetone, and periodically mechanically rubbed, at step 408. The structure is then removed from the keytone reagent, rinsed with DI water, and again dried by a filtered inert gas, at step 410. The structure is rinsed and mechanically rubbed with an alcohol, such as isopropyl alcohol, at step 412. This step should be repeated as necessary.

The structure is then briefly mechanically rubbed with a solution containing a mixed strong acids (e.g., −1 minute), at step 414. In one aspect of the invention, the strong acid solution comprises hydrofluoric acid (HF), nitric acid (HNO₃), and water (H₂O).

In another aspect of the invention, the solution comprises by proportion of HF to HNO₃ to H₂O (e.g., HF:HNO₃:H₂O) between about 1:1:1 and about 1:1:50 (e.g., between about 33%:33%:33% and about 2%:2%:96%).

In another aspect of the invention, the solution comprises by proportion of HF:HNO₃:H₂O between about 1:1:2 and about 1:1:50 (e.g., between about 25%:25%:50% and about 2%:2%:96%).

In another aspect of the invention, the solution comprises by proportion of HF:HNO₃:H₂O of about 1:1:48 (e.g., about 2%:2%:96%).

The structure is then again rinsed with DI water, and dried by a filtered inert gas, at step 416. The structure is then exposed to a weak acidic solution (CH₃COOH) for a substantially long period (e.g., 10 minute), at step 420. In once aspect of the invention, the weak acidic solution is acetic acid. In another aspect of the invention, the weak acidic solution comprises from about 2% to about 10% of the solution. In another aspect of the invention, the weak acidic solution comprises from about 2% to about 6% of the solution. In another aspect of the invention, the weak acidic solution comprises from about 4% to about 5% of the solution.

The structure is then again rinsed with DI water, and dried by a filtered inert gas, at step 422.

The structure is then mechanically rubbed with an alkaline solution for a substantially long period (e.g., ˜10 minute), at step 424.

In one aspect of the invention, the alkaline solution comprises ammonia (NH₄OH), hydrogen peroxide (H₂O₂), and water (H₂O).

In another aspect of the invention, the solution comprises by proportion of NH₄OH to H₂O₂ to H₂O (e.g., NH₄OH:H₂O₂:H₂O) between about 1:1:1 and about 1:1:10 (e.g., between about 33%:33%:33% and about 8%:8%:83%).

In another aspect of the invention, the solution comprises by proportion of NH₄OH:H₂O₂:H₂O between about 1:1:1 and about 1:1:5 (e.g., between about 33%:33%:33% and about 14%:14%:71%).

In another aspect of the invention, the solution comprises by proportion of NH₄OH:H₂O₂:H₂O about 1:1:2 (e.g., about 25%:25%:50%).

The structure is then rinsed with DI water, and dried by a filtered inert gas, at step 426.

While this invention has been described in terms of several preferred embodiments, there are alterations, permutations, and equivalents which fall within the scope of this invention. For example, although the present invention has been described in connection with gas distribution plates of Metal Etch 2300 plasma processing system, other plasma processing systems may be used. It should also be noted that there are many alternative ways of implementing the methods of the present invention.

Advantages of the invention include methods for cleaning etch byproducts from a set of structures comprising yttrium oxide in a plasma processing system. Additional advantages include substantially reducing the use of potentially damaging acids in the cleaning process, prolonging the useful life of yttrium oxide coated structures within a plasma processing system by minimizing yttria coating erosion, and by potentially increasing the yield of the plasma processing process itself.

Having disclosed exemplary embodiments and the best mode, modifications and variations may be made to the disclosed embodiments while remaining within the subject and spirit of the invention as defined by the following claims.

1. In a plasma processing system, a method of removing a set of particles from a set of structures including yttrium oxide, comprising:
exposing said set of structures to a first solution including an oxidizer for a first period;
removing said set of structures from said first solution;
exposing said set of structures to a second solution including a keytone reagent for a second period;
removing said set of structures from said second solution; and
mechanically rubbing a surface of said set of structures with a third solution including a first set of acids for a third period.

2. The method of claim 1, further including the steps of:
exposing said set of structures to a fourth solution including a second set of acids for a fourth period; and
exposing said set of structures to a fifth solution including a first set of alkalines for a fifth period.

3. The method of claim 1, wherein said step of exposing said set of structures in said first solution for a first period further includes mechanically rubbing said set of structures with an abrasive pad.

4. The method of claim 2, wherein said step of removing said set of structures from said first solution further includes rinsing said set of structures with de-ionized water.

5. The method of claim 4, further including drying said set of structures with a filtered inert gas.

6. The method of claim 5, wherein said filtered inert gas comprises nitrogen.

7. The method of claim 2, wherein said step of exposing said set of structures to said second solution for a second period further includes cleaning said set of structures ultrasonically.

8. The method of claim 2, wherein after said step of exposing said set of structures in said second solution for a second period, said set of structures are rinsed and mechanically rubbed with an alcohol.

9. The method of claim 2, wherein said step of removing said set of structures from said second solution further includes rinsing said set of structures with de-ionized water.

10. The method of claim 9, further including drying said set of structures with a filtered inert gas.

11. The method of claim 10, wherein said filtered inert gas comprises nitrogen.

12. The method of claim 11, wherein said step of removing said set of structures from said third solution further includes rinsing said set of structures with de-ionized water.

13. The method of claim 12, further including drying said set of structures with a filtered inert gas.

14. The method of claim 13, wherein said filtered inert gas comprises nitrogen.

15. The method of claim 2, wherein said step of removing said set of structures from said forth solution further includes rinsing said set of structures with de-ionized water.

16. The method of claim 15, further including drying said set of structures with a filtered inert gas.

17. The method of claim 16, wherein said filtered inert gas comprises nitrogen.

18. The method of claim 11, wherein said step of removing said set of structures from said fifth solution further includes rinsing said set of structures with de-ionized water.

19. The method of claim 15, further including drying said set of structures with a filtered inert gas.

20. The method of claim 16, wherein said filtered inert gas comprises nitrogen.

21. The method of claim 2, wherein said oxidizer comprises H₂O₂.

22. The method of claim 2, wherein said second solution comprises H₂O₂.

23. The method of claim 22, wherein said H₂O₂ comprises from about 10% to about 30% of said second solution.

24. The method of claim 22, wherein said H₂O₂ comprises from about 20% to about 30% of said second solution.

25. The method of claim 22, wherein said H₂O₂ comprises about 30% of said second solution.

26. The method of claim 2, wherein said first period comprises 30 minutes.

27. The method of claim 2, wherein said keytone reagent comprises acetone.

28. The method of claim 2, wherein said second period comprises 5 minutes.

29. The method of claim 2, wherein said third solution comprises H₂O₂.

30. The method of claim 2, wherein said first set of acids comprises HF.

31. The method of claim 30, wherein said HF comprises from about 2% to about 33% of said third solution.

32. The method of claim 30, wherein said HF comprises from about 2% to about 25% of said third solution.

33. The method of claim 30, wherein said HF comprises of about 2% of said third solution.

34. The method of claim 2, wherein said first set of acids comprises HNO₃.

35. The method of claim 34, wherein said HNO₃ comprises from about 2% to about 33% of said third solution.

36. The method of claim 34, wherein said HNO₃ comprises from about 2% to about 25% of said third solution.

37. The method of claim 34, wherein said HNO₃ comprises of about 2% of said third solution.

38. The method of claim 2, wherein said third period comprises 1 minute.

39. The method of claim 2, wherein said fourth solution comprises H₂O.

40. The method of claim 2, wherein said second set of acids comprises CH₃COOH.

41. The method of claim 40, wherein said CH₃COOH, comprises from about 2% to about 10% Of said fourth solution.

42. The method of claim 40, wherein said CH₃COOH, comprises from about 2% to about 6% of said fourth solution.

43. The method of claim 40, wherein said CH₃COOH, comprises of about 4% to about 5% of said fourth solution.

44. The method of claim 2, wherein said fourth period is about 10 minutes.

45. The method of claim 2, wherein said fourth solution comprises H₂O₂.

46. The method of claim 2, wherein said first set of alkalines comprises NH₄OH.

47. The method of claim 46, wherein said NH₄OH comprises from about 8% to about 33% of said fifth solution.

48. The method of claim 46, wherein said NH₄OH comprises from about 6% to about 33% of said fifth solution.

49. The method of claim 46, wherein said NH₄OH comprises of about 25% of said fifth solution.

50. The method of claim 2, wherein said forth solution comprises H₂O₂.

51. The method of claim 50, wherein said H₂O₂ comprises from about 8% to about 33% of said fifth solution.

52. The method of claim 50, wherein said H₂O₂ comprises from about 6% to about 33% of said fifth solution.

53. The method of claim 50, wherein said H₂O₂ comprises of about 25% of said fifth solution.

54. The method of claim 2, wherein said fifth period is about 10 minutes.

55. In a plasma processing system, a method of removing a set of particles from a set of structures including yttrium oxide, comprising:
exposing said set of structures to a first solution including a keytone reagent for a first period;
removing said set of structures from said first solution;
exposing said set of structures to a second solution including an oxidizer for a second period;
removing said set of structures from said second solution; and
mechanically rubbing a surface of said set of structures with a third solution including a first set of acids for a third period.

56. The method of claim 55, further including the steps of:
exposing said set of structures to a fourth solution including a second set of acids for a fourth period; and
exposing said set of structures to a fifth solution including a first set of alkalines for a fifth period.

57. In a plasma processing system, a method of removing a set of particles from a set of structures including yttrium oxide, comprising:
exposing said set of structures to a first solution including an oxidizer for a first period;
exposing said set of structures to a second solution including a first set of alkalines with said oxidizer for a second period;
removing said set of structures from said second solution; and
mechanically rubbing a surface of said set of structures with said third solution including a first set of acids for a third period.

58. The method of claim 57, further including the step of exposing said set or structures to a solution including a second set of acids for a fourth period.
